(19) United States
(12) Patent Application Publication
(10) Pub. No.: US 2023/0150099 A1
(43) Pub. Date: May 18, 2023

(54) Socket Holding Device for Power Tool

(71) Applicant: Hilti Aktiengesellschaft, Schaan (LI)

(72) Inventor: Jim CHEN, Shanghai (CN)

(21) Appl. No.: 17/915,882

(22) PCT Filed: Mar. 16, 2021
(86) PCT No.: PCT/EP2021/056693

§ 371 Date: Sep. 29, 2022

(30) Foreign Application Priority Data
Mar. 31, 2020 (CN) 202010243805.4

(51) Int. Cl. B25B 23/00; B25B 21/02

(52) U.S. Cl. CPC B25B 23/0035; B25B 21/02

(57) ABSTRACT

A socket holding device for a power tool includes an anvil with a drive square head, a holding bolt, and a stop pin. The holding bolt locks a tool element that is clipped on the drive square head and the holding bolt is supportable elastically in a recessed seat of the drive square head such that the holding bolt is moveable perpendicularly to a rotation axis of the anvil. The stop pin is disposable in a mounting hole of the drive square head and the holding bolt is lockable by the stop pin when the holding bolt is supported elastically in the recessed seat of the drive square head and the stop pin is disposed in the mounting hole. The stop pin has a first portion partially clippable on the holding bolt and a diameter of the first portion is larger than an inner diameter of the mounting hole.

### BACKGROUND AND SUMMARY OF THE INVENTION

The present invention relates to a power tool, in particular to a socket holding device for a power tool and an impact wrench comprising the socket holding device.

Impact power tools are already widely known. An impact wrench is an illustrative example of an impact tool, which can be used to install and remove threaded fasteners. Specifically, an impact tool, in particular an impact wrench, generally comprises a motor as a drive source, a gear speed reduction mechanism and main shaft which rotate as the motor performs a driving action, a hammer body, and an anvil as a torque output shaft. The main shaft and the hammer body are driven by the motor, and can convert rotation of the main shaft to an intermittent rotational striking force (impact) of the hammer body to act on the anvil, in order to provide rotation and striking to the anvil, thereby intermittently transmitting a rotational striking driving force to a top end tool, e.g., a socket or screwdriver head mounted on the anvil to perform tightening/removal of bolts and screws.

The anvil is used for transmitting an output torque, and a socket is mounted and held on a mounting head of the anvil by means of a socket holding device, to facilitate power tool jobs. There are many types of existing socket holding mechanism, e.g., designs such as positioning rings or stop pins. In the patent document CN107405758A previously applied for and disclosed by the Applicant, a socket holding device for an anvil that is simple to operate and stable was provided. In that socket holding device, a holding bolt is locked by two stop pins extending parallel to an anvil rotation axis from a drive square head end face in order to prevent falling out, thereby solving the problem of square head tool clipping heads of anvils breaking or failing very easily in the prior art. However, that stop pin is long and narrow, and made of a soft material with a certain degree of elasticity, and therefore breaks or suffers damage very easily. In addition, that stop pin also comes out of a mounting hole very easily, with the result that the holding bolt also comes out.

An object of the present invention is to provide a structurally simple, stable and durable socket holding device for a power tool.

The socket holding device for a power tool of the present invention comprises an anvil, on which anvil are provided a drive square head for clipping a tool, and a holding bolt for locking a clipped tool element, the holding bolt being supported elastically in the drive square head in such a way as to be moveable perpendicular to a rotation axis of the anvil, the holding bolt being locked by at least one stop pin disposed in a mounting hole of the drive square head, the stop pin comprising a first portion partially clipped on the holding bolt; the diameter of the first portion of the stop pin is slightly larger than the inner diameter of the mounting hole.

The socket holding device of the present invention has the following advantages: since the diameter of the first portion of the stop pin that is clipped on the holding bolt is larger than the diameter of the mounting hole which accommodates the stop pin, i.e., the first portion of the stop pin is in a slight interference fit with the mounting hole, in the fitting process the stop pin is forcibly pressed into the mounting hole until the first portion reaches a region of the holding bolt, in which region the mounting hole is half-open, the first portion of the stop pin being moveably clipped on the holding bolt; and since the diameter of the first portion is larger than the inner diameter of the mounting hole, the stop pin cannot possibly slide out of the mounting hole, and the stability of the socket holding device is thereby ensured.

According to an embodiment of the present invention, the diameter of a second portion, accommodated in the mounting hole, of the stop pin is smaller than the diameter of the first portion and substantially equal to or smaller than the inner diameter of the mounting hole. Thus, the stop pin has a cylinder with a stepped structure, and the second portion of the stop pin is in a clearance fit with the mounting hole; this not only ensures that the first portion of the stop pin is engaged at that end of the mounting hole which adjoins a recessed seat of the holding bolt, but also makes the fitting process simpler and more convenient.

According to another preferred embodiment of the present invention, the holding bolt is constructed to have rotational symmetry and has a narrowed part, the first portion of the stop pin being clipped in the narrowed part of the holding bolt. Two mounting holes are provided, arranged in parallel and symmetrically with respect to the center of the holding bolt, and separated by a distance substantially equal to the width of the recessed seat. Two stop pins are provided, disposed in the two mounting holes respectively. The mounting hole extends parallel to the rotation axis of the anvil from an end face of the drive square head. The stop pin and/or mounting hole being disposed parallel to the rotation axis of the anvil means that the anvil or the drive square head is much less likely to break.

Alternatively, the mounting hole extends perpendicular to the rotation axis of the anvil from a side face of the drive square head. If the mounting hole is provided at the side face of the drive square head, the depth of the mounting hole can be smaller because the side face of the anvil is closer to the recessed seat, and correspondingly, the length of the mounting pin is reduced accordingly; this facilitates fitting, and at the same time the mounting pin is less likely to suffer damage.

Preferably, the stop pin is formed of a heat-treated steel material, and has a hardness not lower than HRC 30. More preferably, the stop pin has a hardness of HRC 58-60. When an existing stop pin is pressed into the anvil, dimensional tolerance must be taken into account because the existing stop pin is a solid pin; too large an interference amount will cause the drive square head of the anvil to burst, whereas too small an interference amount will result in the stop pin possibly coming out of the mounting hole. Thus, the choice is often made to use a softer steel material with better elasticity for construction, in order to achieve the desired dimensional tolerance. However, an elastic stop pin of a softer material is damaged very easily. Thus, the present invention has made an improvement, using a steel material of higher hardness and employing heat treatment, such that the stop pin has greatly increased hardness and is not damaged easily. Moreover, since the stop pin is stepped, only the first portion is in an interference fit with the mounting hole, and the fitting process of the stop pin is simpler and more convenient; the quality is also improved.

The present invention further provides an impact wrench, comprising the socket holding device for a power tool as described above.

The embodiments mentioned can be better understood through the following detailed description while perusing the accompanying drawings. It is emphasized that the various components are not necessarily drawn to scale. In fact, dimensions can be enlarged or reduced at will for the purposes of clear discussion. In the drawings, identical reference labels denote identical elements.

### BRIEF DESCRIPTION OF THE DRAWINGS

FIG. 1 is a perspective view of a schematic embodiment of a socket holding mechanism for a power tool of the present invention.

FIG. 2 shows a schematic drawing of the holding bolt of the socket holding mechanism according to an embodiment of the present invention.

FIG. 3 is a schematic drawing of the stop pin of the socket holding mechanism for a power tool according to an embodiment of the present invention.

FIG. 4 is a perspective view of the stop pin mounted on the anvil drive square head according to an embodiment of the present invention.

FIG. 5 is a partial schematic drawing of the stop pin mounted on the anvil drive square head shown in FIG. 4.

### DETAILED DESCRIPTION OF THE DRAWINGS

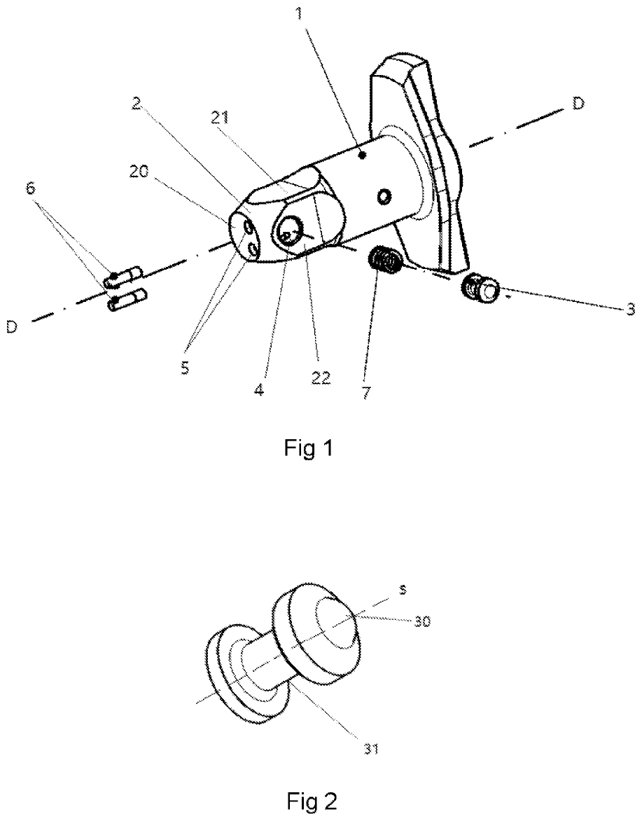

A socket holding device for a power tool and an impact wrench comprising the socket holding device according to an embodiment of the present invention are described below with reference to FIGS. 1-5.

FIG. 1 shows an anvil 1, on which anvil 1 are provided a drive square head 2 for clipping a tool (e.g., an impact wrench socket), which is not shown here, and a holding bolt 3 for locking the socket. A recessed seat 4 is provided on a holding face 22 of the drive square head 2; the recessed seat 4 is a blind hole which starts at the holding face and is perpendicular to a rotation axis D of the anvil. The holding bolt 3 is supported elastically in the recessed seat 4 via a coil spring 7, and the holding bolt 3 is thereby supported in the recessed seat 8 of the drive square head 2 in such a way as to be moveable perpendicular to the rotation axis D of the anvil 1. The holding bolt 3 is locked by at least one stop pin 6.

FIG. 2 shows the holding bolt 3 according to an embodiment of the present invention. The holding bolt 3 is constructed to have rotational symmetry with respect to a center axis S of the holding bolt 3. It can be clearly seen that an upper end of the holding bolt 3 has a hemispherical surface 30; additionally, the holding bolt 3 also has a narrowed part 31, which extends around the holding bolt 3 in the style of a belt. The narrowed part 31 is used for clipping the stop pin 6, with the aim of locking the holding bolt 3 in the drive square head.

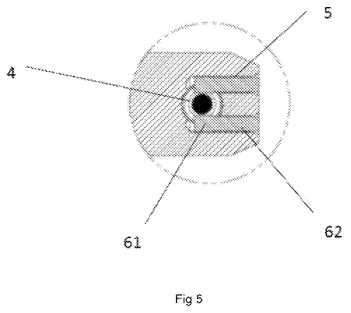

As shown in FIGS. 1 and 4, the stop pin 6 is disposed in a mounting hole 5 of the drive square head 2. Preferably, the mounting hole 5 extends parallel to the rotation axis (D) of the anvil from an end face 20 of the drive square head. The stop pin and/or mounting hole being disposed parallel to the rotation axis of the anvil means that the anvil or the drive square head is much less likely to break. Alternatively, the mounting hole 5 may also be disposed extending perpendicular to the rotation axis (D) of the anvil from a side face 21 of the drive square head. Alternatively, the mounting hole 5 extends perpendicular to the rotation axis (D) of the anvil from a side face 21 of the drive square head 2. If the mounting hole 5 is provided at the side face 21 of the drive square head, the depth of the mounting hole 5 can be smaller because the side face of the anvil is closer to the recessed seat 4, and correspondingly, the length of the mounting pin 6 is reduced accordingly; this facilitates fitting, and at the same time the mounting pin is less likely to suffer damage.

Preferably, there are two mounting holes 5, arranged in parallel and symmetrically with respect to the center axis S of the holding bolt 3, and separated by a distance substantially equal to the width of the recessed seat. Thus, an extremity of the mounting hole 5 at least partially abuts the recessed seat; that is to say, the mounting hole 5 is at least half-open in a region of the recessed seat 4. Correspondingly, there are also two stop pins 6, disposed in the two mounting holes 5 respectively. The holding bolt 3 is a substantially cylindrical structure with a narrowed belt. Thus, a part of the stop pin 6, i.e., a first portion 60 passing through the mounting hole and extending to the recessed seat region, is clipped in the narrowed part 31 of the holding bolt, while a second portion 61—the remaining part of the stop pin—is still held in the mounting hole 5.

The diameter of the first portion 60 of the stop pin of the present invention is larger than the inner diameter of the mounting hole 5. The stop pin 6 is itself a very small component, e.g., the diameter of an existing stop pin is generally about 2 mm; thus, the expression “larger” used here means only very slightly larger, e.g., the diameter of the first portion 60 of the stop pin may only be 0.05-0.1 mm larger than the inner diameter of the mounting hole. This slight difference is necessary. First of all, due to this slight difference in diameter, the first portion 60 of the stop pin is in a slight interference fit with the mounting hole 5. When the stop pin is fitted to the drive square head of the anvil, this slight interference fit amount must not only ensure that the stop pin 6 can be forcibly pressed into the mounting hole 5, but must also ensure that the first portion 60 of the stop pin, after passing through the mounting hole 5 and arriving at the narrowed part 31 of the holding bolt, will not come out of the mounting hole again. Since the mounting hole 5 is at least half-open in the recessed seat region, the first portion 60 of the stop pin is moveably clipped in the narrowed part 3 of the holding bolt, and since the diameter of the first portion 60 is larger than the inner diameter of the mounting hole 5, the stop pin 60 cannot possibly slide out of the mounting hole 5 again; thus the stability of the socket holding device is ensured.

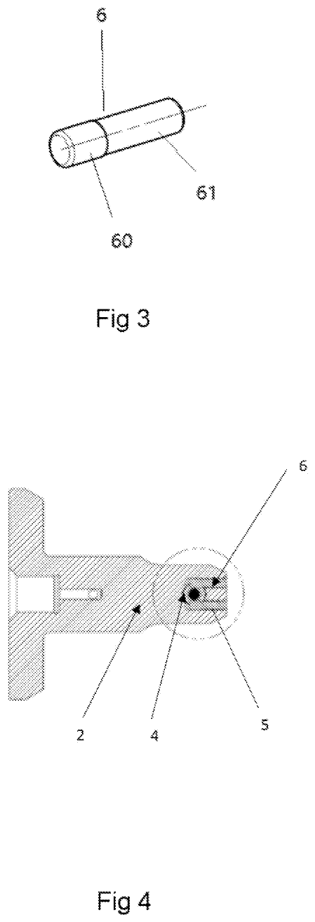

Referring to FIGS. 3-5, the stop pin 6 of the present invention has a stepped structure, comprising the first portion 60 at least partially clipped on the holding bolt and the second portion 61 accommodated in the mounting hole 5; the diameter of the first portion 60 is slightly larger than the diameter of the second portion 61, and the diameter of the second portion 61 is substantially equal to or smaller than the inner diameter of the mounting hole 5. Thus, the second portion 61 of the stop pin is in a clearance fit with the mounting hole 5; this not only ensures that the first portion 60 of the stop pin is engaged at that end of the mounting hole which adjoins the recessed seat of the holding bolt, but also makes the fitting process simpler and more convenient.

According to another preferred embodiment of the present invention, preferably, the stop pin 6 is formed of a heat-treated steel material, and has a hardness not lower than HRC 20-30. More preferably, the stop pin 6 has a hardness of HRC 58-60. When an existing stop pin is pressed into the drive square head 2 of the anvil, dimensional tolerance must be taken into account because the existing stop pin is a solid pin; too large an interference amount will cause the drive square head of the anvil to burst, whereas too small an interference amount will result in the stop pin 6 possibly coming out of the mounting hole 5. Thus, the choice is often made to use a softer steel material with better elasticity for construction, in order to achieve the desired dimensional tolerance. However, an elastic stop pin of a softer material is damaged very easily. Thus, the present invention has made an improvement, using a steel material of higher hardness and employing heat treatment, such that the stop pin has greatly increased hardness and is not damaged easily. Moreover, since the stop pin 6 is stepped, only the first portion 60 is in an interference fit with the mounting hole 5, and the fitting process of the stop pin is simpler and more convenient; the quality is also improved.

In addition, the present invention further relates to an impact wrench comprising the socket holding device. The socket holding device of the present invention is suitable for a power-driven tool, for example an impact wrench. It is particularly suitable in cases where it is necessary to connect a socket for a job to a torque output shaft. In the socket holding device according to the present invention, the holding bolt 3 is supported in the recessed seat 4 of the drive square head under the action of the spring 7, with the hemispherical surface 30 thereof protruding from the holding face 22 of the drive square head 2. When a socket is fitted onto the drive square head in a sheathing manner, the socket slides along the hemispherical surface 30, causing the spring 7 to be compressed downwards, such that the holding bolt 3 moves downwards along the center axis thereof until the highest point of the hemispherical surface 30 is flush with the holding face of the drive square head 2. The socket continues to slide along the drive square head 2 until a positioning pin hole in the socket reaches the position of the holding bolt 3, at which time the holding bolt 3 springs into the positioning pin hole in the socket under the action of the spring 7. The socket is thereby firmly positioned and held on the drive square head 2, in order to perform a desired job such as tightening a bolt.

As stated above, although demonstrative embodiments of the present invention have already been explained herein with reference to the accompanying drawings, the present invention is not limited to the particular embodiments described above; many other embodiments are possible, and the scope of the present invention should be defined by the claims and their equivalent meaning.

1.-10. (canceled)

11. A socket holding device for a power tool, comprising:
an anvil with a drive square head;
a holding bolt for locking a tool element that is clipped on the drive square head, wherein the holding bolt is supportable elastically in a recessed seat of the drive square head such that the holding bolt is moveable perpendicularly to a rotation axis of the anvil; and
a stop pin disposable in a mounting hole of the drive square head, wherein the holding bolt is lockable by the stop pin when the holding bolt is supported elastically in the recessed seat of the drive square head and the stop pin is disposed in the mounting hole, wherein the stop pin has a first portion partially clippable on the holding bolt, and wherein a diameter of the first portion of the stop pin is larger than an inner diameter of the mounting hole.

12. The socket holding device for a power tool according to claim 11, wherein the stop pin has a second portion, wherein a diameter of the second portion is smaller than the diameter of the first portion and substantially equal to or smaller than the inner diameter of the mounting hole.

13. The socket holding device for a power tool according to claim 11, wherein the holding bolt has a rotational symmetry and has a narrowed part and wherein the first portion of the stop pin is clippable in the narrowed part of the holding bolt when the holding bolt is supported elastically in the recessed seat of the drive square head and the stop pin is disposed in the mounting hole.

14. The socket holding device for a power tool according to claim 11, wherein the drive square head has a second mounting hole and wherein the mounting holes are disposed in parallel and symmetrically with respect to a center of the holding bolt and are separated by a distance substantially equal to a width of the recessed seat.

15. The socket holding device for a power tool according to claim 14, wherein the mounting holes extend parallel to the rotation axis of the anvil from an end face of the drive square head.

16. The socket holding device for a power tool according to claim 11, wherein the mounting hole extends perpendicularly to the rotation axis of the anvil from a side face of the drive square head.

17. The socket holding device for a power tool according to claim 14, further comprising a second stop pin, wherein the second stop pin is disposable in the second mounting hole of the drive square head.

18. The socket holding device for a power tool according to claim 11, wherein the stop pin is formed of a heat-treated steel material and has a hardness not lower than HRC 30.

19. The socket holding device for a power tool according to claim 18, wherein the stop pin has a hardness of HRC 58-62.

20. An impact wrench, comprising:
the socket holding device for a power tool according to claim 11.
